(19) United States
(12) Patent Application Publication
(10) Pub. No.: US 2019/0057478 A1
(43) Pub. Date: Feb. 21, 2019

(54) METHOD AND SYSTEM FOR PROVIDING TRANSPORTATION SERVICE INFORMATION

(71) Applicant: Beijing Didi Infinity Technology and Development Co., Ltd., Beijing (CN)

(72) Inventor: Qian Mu, Beijing (CN)

(73) Assignee: Beijing Didi Infinity Technology and Development Co., Ltd., Beijing (CN)

(21) Appl. No.: 15/856,150

(22) Filed: Dec. 28, 2017

(30) Foreign Application Priority Data
Aug. 16, 2017 (CN) 201710702348.9

(51) Int. Cl. G06Q 50/30; G06Q 30/02

(52) U.S. Cl. CPC G06Q 50/30; G06Q 30/0201; G06Q 30/0205

(57) ABSTRACT

Systems and methods for providing transportation service information are disclosed. An exemplary method for providing transportation service information may include obtaining a location of a terminal device and obtaining supply and demand data for a region surrounding the location of the terminal device. The method may also include identifying, via a processor, at least one high demand area within the region and identifying, via the processor, at least one supply shortage area based on supply available in the at least one high demand area. The method may further include providing, utilizing the terminal device, at least one indication indicating the at least one supply shortage area on a map.

### CROSS REFERENCE TO RELATED APPLICATION

The present application is based on and claims the benefits of priority to Chinese Application No. 201710702348.9, filed Aug. 16, 2017, the entire contents of which are incorporated herein by reference.

### TECHNICAL FIELD

The present disclosure relates to providing transportation services, and more particularly, to methods and systems for providing transportation service information.

### BACKGROUND

An online hailing platform (e.g., DiDi™ online) can receive a transportation service request from a passenger and then route the service request to at least one transportation service provider (e.g., a taxi driver, a private car owner, or the like). The service request can be answered by a service provider, or assigned to a service provider if no one picks up the service request within a predetermined period.

When an online hailing platform receives a large number of transportation service requests within a given area, the online hailing platform may place the transportation service requests in a queue so that service vehicles can be assigned to serve the transportation service requests in the queue according to a predetermined regulation. Such areas may be referred to as high demand areas, and in certain situations, drivers of service vehicles located outside of high demand areas may be notified of the locations of the high demand areas so that they can choose to drive to one of such areas to provide services.

It is noted, however, that notifying drivers of the locations of high demand areas may be misleading. For example, while there may be a high demand for transportation services in a particular area, the number of service vehicles available in the area may be high as well. Therefore, it may not be worthwhile for drivers located outside of the area to drive to the area. Embodiments of the present disclosure provide methods and systems that address the aforementioned shortcomings.

### SUMMARY

Embodiments of the disclosure provide a computer-implemented method for providing transportation service. The method may include obtaining a location of a terminal device and obtaining supply and demand data for a region surrounding the location of the terminal device. The method may also include identifying, via a processor, at least one high demand area within the region and identifying, via the processor, at least one supply shortage area based on supply available in the at least one high demand area. The method may further include providing, utilizing the terminal device, at least one indication indicating the at least one supply shortage area on a map.

Embodiments of the disclosure further disclose a device for providing transportation service. The device may include a communication interface, at least one memory, and at least one processor coupled to the communication interface and the at least one memory. The communication interface may be configured obtain a location of a terminal device and obtain supply and demand data for a region surrounding the location of the terminal device. The at least one processor may be configured to identify at least one high demand area within the region and identify at least one supply shortage area based on supply available in the at least one high demand area. The at least one processor may also be configured to provide at least one indication on the terminal device. The at least one indication may indicate the at least one supply shortage area on a map.

Embodiments of the disclosure further disclose a non-transitory computer-readable medium. The non-transitory computer-readable medium may store a set of instructions, when executed by at least one processor of an electronic device, cause the electronic device to perform a method for providing transport service. The method may include obtaining a location of a terminal device and obtaining supply and demand data for a region surrounding the location of the terminal device. The method may also include identifying at least one high demand area within the region and identifying at least one supply shortage area based on supply available in the at least one high demand area. The method may further include providing, utilizing the terminal device, at least one indication indicating the at least one supply shortage area on a map.

It is to be understood that both the foregoing general description and the following detailed description are exemplary and explanatory only and are not restrictive of the invention, as claimed.

### BRIEF DESCRIPTION OF THE DRAWINGS

FIG. 1 illustrates a schematic diagram of an exemplary system for providing transportation service information, according to embodiments of the disclosure.

FIG. 2 illustrates a block diagram of an exemplary device for providing transportation service information, according to embodiments of the disclosure.

FIG. 3 illustrates passengers and vehicles within an exemplary area, according to embodiments of the disclosure.

FIG. 4A illustrates an exemplary user interface displayed on a terminal device, according to embodiments of the disclosure.

FIG. 4B illustrates another exemplary user interface displayed on a terminal device, according to embodiments of the disclosure.

FIG. 4C illustrates yet another exemplary user interface displayed on a terminal device, according to embodiments of the disclosure.

FIG. 5 illustrates a flowchart of an exemplary method for providing transportation service information, according to embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

An aspect of the disclosure is directed to a system for providing transportation service information. In some embodiments, the system may be configured to obtain the location of a terminal device (e.g., a mobile phone used by a driver of a service vehicle, a navigation device onboard the service vehicle, or the like). The system may also be configured to obtain supply and demand data for a region surrounding the location of the terminal device. The system may process the supply and demand data to identify one or more supply shortage areas within the region. The system may then provide an indication to a user of the terminal device (e.g., the driver of the service vehicle). The indication may indicate to the user locations of one or more supply shortage areas on a map. In some embodiments, the indication may be presented as a heat map. In some embodiments, the indication may include a ranking of the supply shortage areas (e.g., ranked based on the degree of shortages associated with the respective supply shortage areas). In some embodiments, one of the supply shortage areas may be selected (e.g., automatically or manually) as a destination, and the system may help the user navigate to the destination.

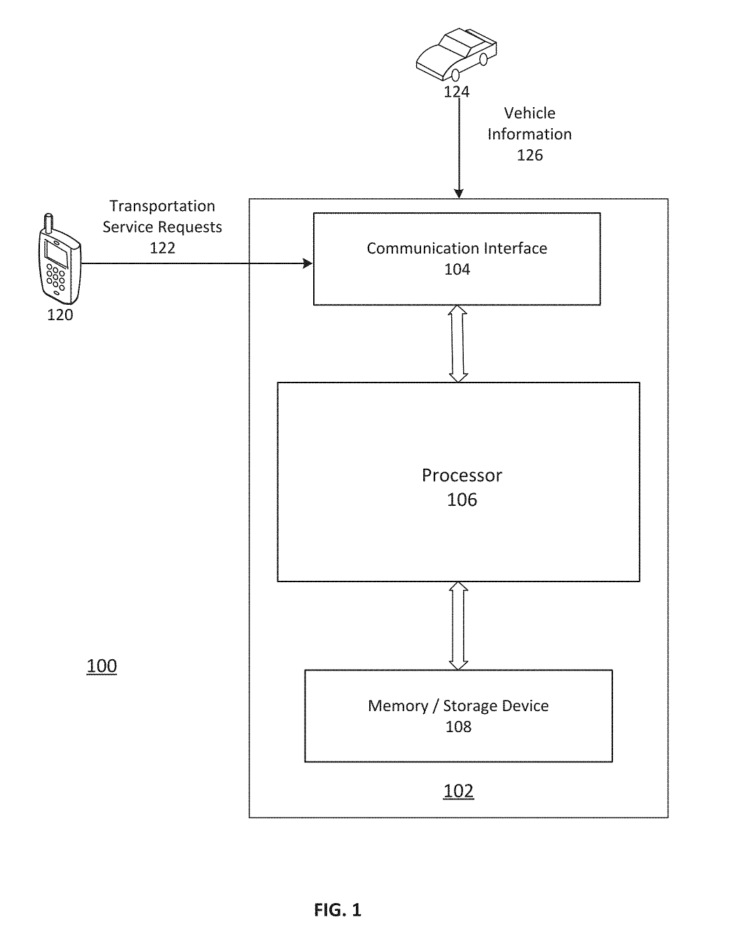

FIG. 1 illustrates a schematic diagram of an exemplary system 100 for providing transportation service information, according to embodiments of the disclosure.

System 100 may include a transportation service management server 102 (also referred to as server 102 for simplicity). Server 102 can be a general-purpose server or a proprietary device specially designed for providing transportation service. It is contemplated that, server 102 can be a stand-alone system (e.g., a server) or an integrated component of a stand-alone server. Because processing transportation service may require significant computation resources, in some embodiments, server 102 may be preferably implemented as a stand-alone system. In some embodiments, server 102 may include sub-systems, some of which may be remote.

In some embodiments, as shown in FIG. 1, server 102 may include a communication interface 104, a processor 106, and a memory/storage device 108. Processor 106 may include one or more hardware units (e.g., portions of an integrated circuit) designed for use with other components or to execute a part of a program. The program may be stored on a computer-readable medium, and when executed by processor 106, it may perform one or more functions. Although FIG. 1 shows communication interface 104, processor 106, and memory/storage device 108 all within one server 102, it is contemplated that these components may be distributed among multiple devices located near to or remotely with respect to each other. In some embodiments, server 102 may be implemented in the cloud, or on a separate computer/server.

Communication interface 104 can be an integrated services digital network (ISDN) card, cable modem, satellite modem, or a modem to provide a data communication connection. As another example, communication interface 104 can be a local area network (LAN) card to provide a data communication connection to a compatible LAN. Wireless links can also be implemented by communication interface 104. In such an implementation, communication interface 104 can send and receive electrical, electromagnetic or optical signals that carry digital data streams representing various types of information via a network. The network can typically include a cellular communication network, a Wireless Local Area Network (WLAN), a Wide Area Network (WAN), or the like.

Communication interface 104 may be configured to receive transportation service requests 122 from passenger terminals 120. A passenger terminal 120 may include any suitable terminal device that can interact with a passenger, e.g., a smart phone, a tablet, a wearable device, a computer, or the like. Transportation service request 122 may include a current location of the passenger, an origin and a destination of the requested transportation service, a request time, or the like. Generally, the origin of the requested transportation service can be the same or substantially close to a location of the remote passenger terminal 120. However, it is contemplated that, the origin of the requested transportation can also differ from the location of the remote passenger terminal 120, even if transportation service request 122 is sent from terminal 120. For example, a user can request a transportation service from a computer for his friend, who is distant from this user. Server 102 can generate an estimated price and send the estimated price back to the terminal for displaying to the passenger.

Communication interface 104 may also be configured to receive vehicle information 126 from one or more service vehicles 124. Service vehicles 124 may include taxi cars or private cars enrolled with the online hailing platform. Service vehicles 124 may also include autonomous vehicles. In some embodiments, service vehicles 124 may be associated with terminal devices such as navigation devices onboard the vehicles 124 or mobile devices used by their drivers (e.g., smart phones, tablets, wearable devices, computers, or the like). These terminal devices may communicate with server 102 and provide vehicle information 126 to server 102 via communication interface 104. Vehicle information 126 provided in this manner may include locations, capacities, current driving directions, vehicle makers and models, as well as other features or characteristics associated with service vehicles 124.

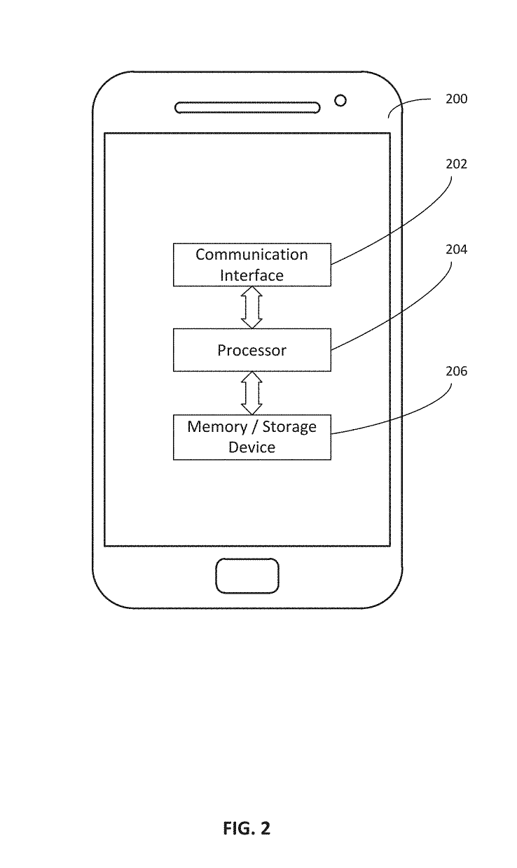

FIG. 2 is a block diagram depicting an exemplary terminal device 200 associated with a service vehicle 124. Terminal device 200 may include a communication interface 202, a processor 204, and a memory/storage device 206. Communication interface 202 may be configured in a manner similar to communication interface 104. Communication interface 202 may facilitate communications between terminal device 200 and server 102. Processor 204 may include one or more hardware units (e.g., portions of an integrated circuit) designed for use with other components or to execute a part of a program. The program may be stored on a computer-readable medium (e.g., memory/storage device 206), and when executed by processor 204, it may perform one or more functions.

For instance, in some embodiments, processor 204 may be configured to obtain the location of terminal device 200 and identify a region surrounding the location of terminal device 200. The region may include one or more areas within a predetermined distance (e.g., 4 kilometers) away from the location of terminal device 200. Alternatively, the region may include the city (or a portion of the city) where terminal device 200 is located. It is to be understood that the region may be identified in various other manners without departing from the spirit and scope of the present disclosure.

Processor 204 may also be configured to obtain supply and demand data for the region identified. In some embodiments, processor 204 may obtain the supply and demand data for the region from server 102. Because server 102 is configured to receive vehicle information 126 from service vehicles and transportation service requests 122 from passengers, server 102 may be able to provide data representing available service vehicles in the region (supply data) and data representing transportation service requests received from passengers in the region (demand data) to processor 204 upon request.

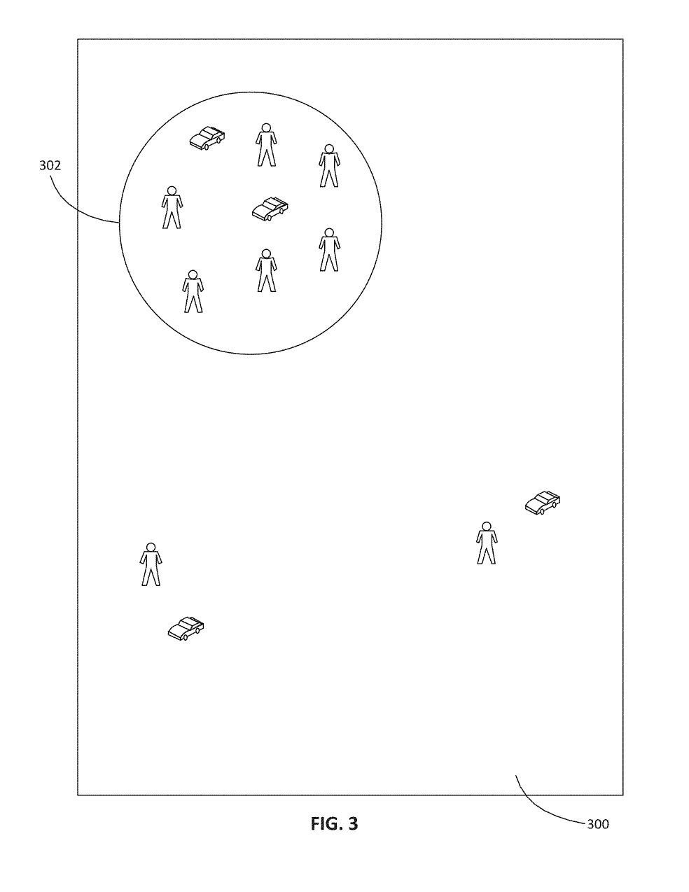

Processor 204 may analyze the demand data to identify one or more areas within the region where transportation service requests are concentrated. Such areas may be referred to as high demand areas. For example, processor 204 may retrieve location data associated with the transportation service requests and utilize analysis techniques such as clustering or the like to identify high demand areas within the region. FIG. 3 illustrates an exemplary high demand area 302 where transportation service requests are concentrated within a region 300. Processor 204 may also determine the number of service vehicles available to fulfill transportation service requests in area 302. If the difference between the number of transportation service requests received in area 302 and the number of service vehicles available in area 302 is greater than a threshold, processor 204 may identify area 302 as a supply shortage area. On the other hand, if the difference between the number of transportation service requests received in area 302 and the number of service vehicles available in area 302 is below the threshold, processor 204 may not need to identify area 302 as a supply shortage area even though area 302 has high demand for transportation services.

It is to be understood that while area 302 depicted in FIG. 3 is a circular area, such a depiction is merely exemplary and is not meant to be limiting. It is contemplated that area 302 may contain other shapes (e.g., rectangular, hexagonal, or the like). It is also contemplated that area 302 may contain an area having a shape and a size dynamically determined based on supply and demand data without departing from the spirit and scope of the present disclosure.

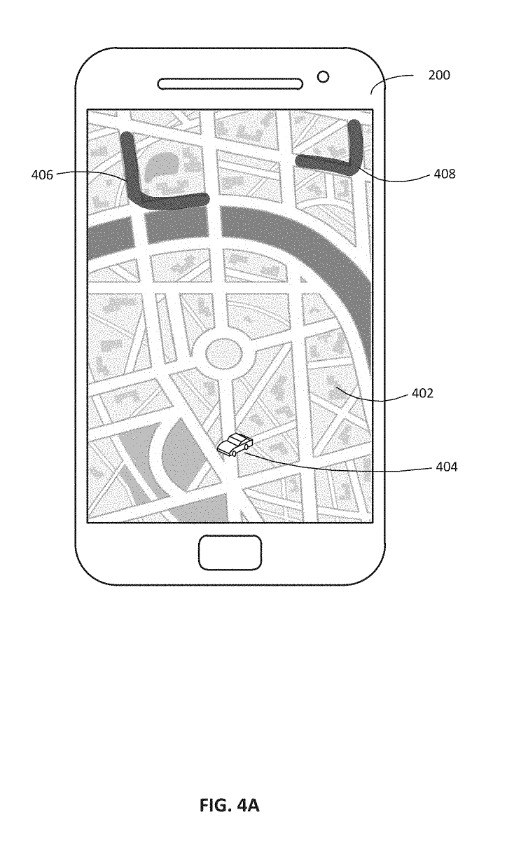

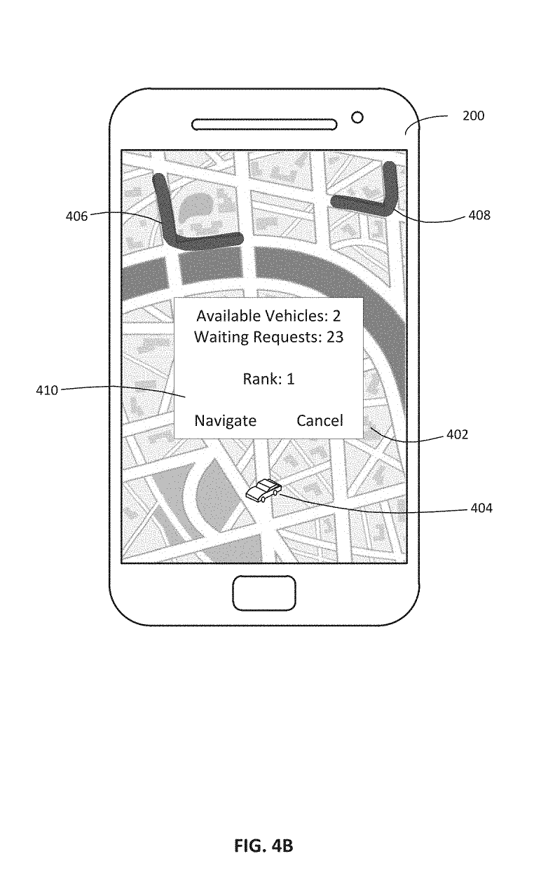

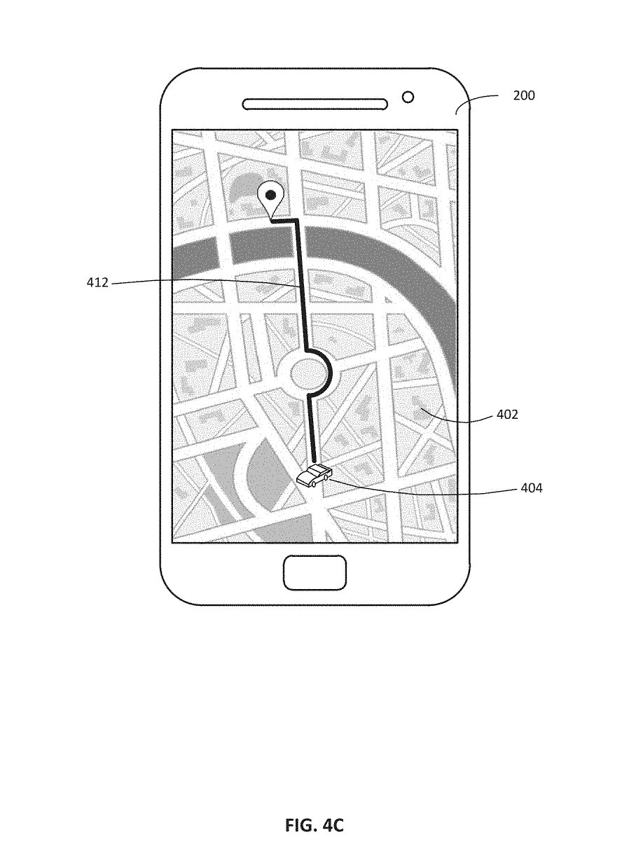

Processor 204 may provide indications of the one or more supply shortage areas to the user of terminal device 200. In some embodiments, processor 204 may provide indications on a map displayed by terminal device 200. FIG. 4A illustrates an exemplary indication. Specifically, for illustrative purposes, suppose terminal device 200 is used by the driver of a service vehicle (depicted by reference number 404 in FIG. 4A). Processor 204 may provide the indication on terminal device 200 to indicate the locations of supply shortage areas (e.g., 406 and 408) on a map 402. In some embodiments, processor 204 may simply mark the locations or display the addresses of supply shortage areas 406 and 408. Alternatively or additionally, processor 204 may indicate the locations of supply shortage areas 406 and 408 on a heat map. The heat map may be generated based on the difference between the number of transportation service requests received in supply shortage areas (e.g., 406 and 408) and the number of service vehicles available in those areas. In this manner, if supply shortage area 406 has a severer shortage compared to supply shortage area 408 (e.g., the difference between the number of transportation service requests received in supply shortage area 406 and the number of service vehicles available in supply shortage area 406 is greater than the difference in supply shortage area 408), processor 204 may indicate supply shortage area 406 differently from (e.g., with more emphasis than) supply shortage area 408 (e.g., using a different color, brightness, intensity, or the like). It is to be understood that processor 204 may generate the heat map in various different manners without departing from the spirit and scope of the present disclosure.

In some embodiments, processor 204 may rank the supply shortage areas based on various criteria. For example, processor 204 may rank the supply shortage areas based on the degree of shortages associated with the supply shortage areas. Processor 204 may indicate the ranking information to the user of terminal device 200. FIG. 4B illustrates an exemplary indication of ranking information 410. Processor 204 may also provide the ranking information as numbers displayed next to the supply shortage areas. Alternatively or additionally, processor 204 may indicate the ranking information using different colors. For example, processor 204 may assign red to the highest ranked supply shortage area, green to the lowest ranked supply shortage area, and a range of colors to the supply shortage areas in between. It is to be understood that processor 204 may utilize other types of visual representations to indicate ranking information without departing from the spirit and scope of the present disclosure.

In some embodiments, processor 204 may be configured to automatically select one of the supply shortage areas as a recommended destination. Processor 204 may, for example, select the highest ranked supply shortage area as the recommended destination. Alternatively, processor 204 may select the nearest supply shortage area as the recommended destination. It is to be understood that the user of terminal device 200 may program or customize the selection scheme utilized by processor 204. It is also to be understood that the user of terminal device 200 may select one of the supply shortage areas as the destination (or override the recommended destination selected by processor 204) by manually selecting one of the supply shortage areas and initiate a navigation command. Once the destination is selected (e.g., either manually or automatically), processor 204 may indicate the destination address, determine a route to the destination, and provide the route to the user using terminal device 200. FIG. 4C illustrates such an exemplary route 412 to the selected destination.

It is to be understood that the user interfaces depicted in FIGS. 4A-4C are merely exemplary and are not meant to be limiting. It is contemplated that other types of user interfaces may be utilized to provide other types of information to the user without departing from the spirit and scope of the present disclosure.

It is to be understood that while the description above referenced processor 204 as the processor configured to identify the region surrounding the location of terminal device 200 and the processor configured to identify one or more supply shortage areas within the region, such a configuration is merely exemplary and is not meant to be limiting. It is contemplated that because processor 106 of server 102 also have access to service vehicle information, processor 106 may be configured to identify the region surrounding the service vehicle and identify one or more supply shortage areas within the region. It is therefore contemplated that processor 204 and processor 106 may jointly or independently carry out the functions described above without departing from the spirit and scope of the present disclosure. It is also contemplated that in some embodiments, processor 106 may be configured to maintain one or more service queues when the number of transportation service requests received in a region or area exceeds the number of service vehicles in that region or area. In such embodiments, processor 106 may provide data representing the service queues (e.g., including queues sizes) to processor 204. It is contemplated that processor 204 may identify one or more supply shortage areas based on service queue data. For example, in some embodiments, processor 204 may identify an area as a supply shortage area if the area contains a service queue having a queue size greater than a threshold.

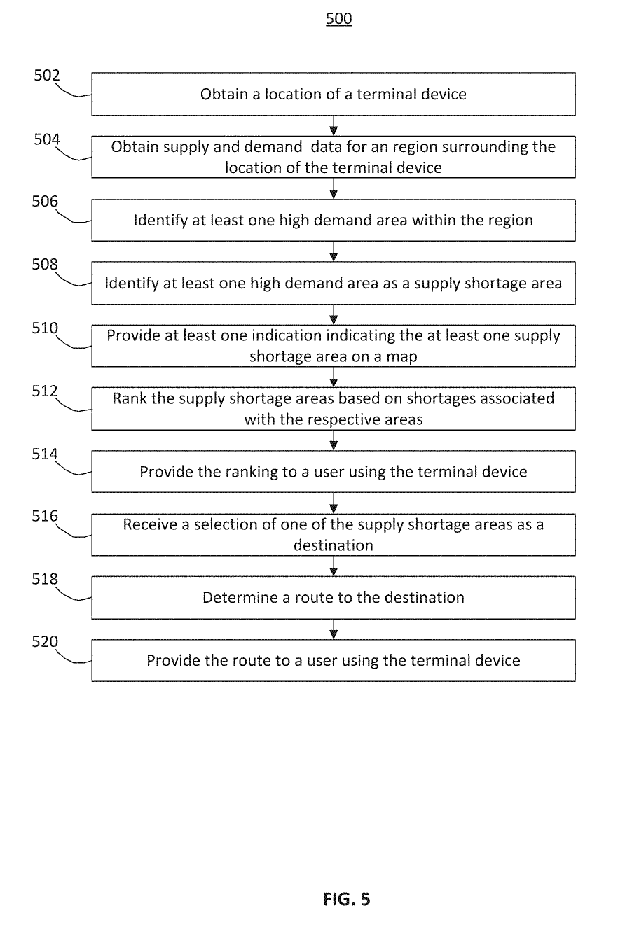

Another aspect of the disclosure is directed to a method for providing transportation service information. FIG. 5 is a flowchart illustrating an exemplary method 500 for providing transportation service information consistent with disclosed embodiments. Method 500 may be implemented by server 102 and/or terminal device 200, each including at least one processor. In the description below, processor 204 is used as an example for implementing method 500. It is contemplated that method 500 can also be implemented by processor 106, or jointly by processors 204 and 106. Method 500 may include several steps as described below, some of which may be optional.

In step 502, processor 204 may obtain a location of a terminal device. In step 504, processor 204 may obtain supply and demand data for a region surrounding the location of the terminal device. The region may include areas within a predetermined distance away from the location of the terminal device. Alternatively, the region may include the city (or a portion of the city) where the terminal device is located. It is to be understood that the region may be identified in various other manners without departing from the spirit and scope of the present disclosure.

The supply and demand data may include data representing available service vehicles in the region (supply data) and data representing transportation service requests received from passengers in the region (demand data). In step 506, processor 204 may process the supply and demand data to identify one or more areas within the region where transportation service requests are concentrated. Such areas may be referred to as high demand areas. For example, processor 204 may retrieve location data associated with the transportation service requests and utilize analysis techniques such as clustering or the like to identify high demand areas within the region. In step 508, processor 204 may determine the number of service vehicles available to fulfill transportation service requests in the identified high demand areas. If the difference between the number of transportation service requests received in a high demand area and the number of service vehicles available in that area is greater than a threshold, processor 204 may identify that area as a supply shortage area. Otherwise, processor 204 may not need to identify that area as a supply shortage area even though the area has high demand for transportation services.

In step 510, processor 204 may provide indications of the one or more supply shortage areas to a user of the terminal device. In some embodiments, the locations of the supply shortage areas may be marked on a map displayed by the terminal device. Alternatively, the locations of the supply shortage areas may be indicated using a heat map. The heat map may be generated based on the difference between the number of transportation service requests received in the supply shortage areas and the number of service vehicles available in those areas. In this manner, if a first supply shortage area has a severer shortage of supply compared to a second supply shortage area, processor 204 may indicate the first supply shortage area differently from (e.g., with more emphasis than) the second supply shortage area (e.g., using a different color, brightness, intensity, or the like).

In step 512, processor 204 may rank the supply shortage areas based on various criteria. For example, processor 204 may rank the supply shortage areas based on the degree of shortages associated with the supply shortage areas. Processor 204 may then provide the ranking information to the user of the terminal device in step 514. In some embodiments, processor 204 may provide the ranking information in a text format. Alternatively or additionally, processor 204 may provide the ranking information as numbers displayed next to the supply shortage areas. In some embodiments, processor 204 may indicate the ranking information using different colors. It is to be understood that processor 204 may utilize other types of visual representations to indicate ranking information in step 514 without departing from the spirit and scope of the present disclosure.

In some embodiments, processor 204 may be configured to receive, in step 516, a selection of one of the supply shortage areas as a destination. The destination may be selected manually (e.g., by the user) or automatically (e.g., based on certain predetermined selection scheme). Once the destination is selected (e.g., either manually or automatically), processor 204 may determine a route to the destination (in step 518) and provide the route to the user using terminal device (in step 520), as previously described.

Another aspect of the disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed system and related methods. Other embodiments will be apparent to those skilled in the art from consideration of the specification and practice of the disclosed system and related methods.

It is intended that the specification and examples be considered as exemplary only, with a true scope being indicated by the following claims and their equivalents.

What is claimed is:

1. A computer-implemented method for providing transportation service, comprising:
obtaining a location of a terminal device;
obtaining supply and demand data for a region surrounding the location of the terminal device;
identifying, via a processor, at least one high demand area within the region;
identifying, via the processor, at least one supply shortage area based on supply available in the at least one high demand area; and
providing, utilizing the terminal device, at least one indication indicating the at least one supply shortage area on a map.

2. The method of claim 1, comprising:
generating a heat map on the map based on a number of transportation service requests received in the at least one supply shortage area and a number of service vehicles available to fulfill the transportation service requests in the respective supply shortage area.

3. The method of claim 1, comprising:
obtaining the supply and demand data from a transportation service management server.

4. The method of claim 1, wherein the region includes one or more areas within a predetermined distance away from the location of the terminal device.

5. The method of claim 1, wherein the supply and demand data comprises data representing a number of vehicles available to fulfill transportation service requests associated with each area in the region and data representing a number of transportation service requests received in the respective area.

6. The method of claim 5, comprising:
identifying the at least one high demand area based on the number of transportation service requests received in the respective area; and
identifying at least one high demand area as a supply shortage area when a difference between the number of transportation service requests received in the high demand area and the number of service vehicles available in the high demand area is greater than a threshold.

7. The method of claim 1, wherein the at least one supply shortage area comprises a plurality of supply shortage areas, and wherein the method further comprises:
ranking, via the processor, the plurality of supply shortage areas based on a degree of shortage associated with the respective supply shortage areas; and
providing the ranking of the plurality of supply shortage areas to a user utilizing the terminal device.

8. The method of claim 1, wherein the supply and demand data comprises data representing a number of vehicles available to fulfill transportation service requests associated with each area in the region within a time period and data representing a number of transportation service requests received in the respective area within the time period.

9. The method of claim 1, further comprising:
receiving a selection of one of the at least one supply shortage area as a destination;
determining a route to the destination; and
providing the route to a user utilizing the terminal device.

10. The method of claim 1, further comprising:
automatically selecting one of the at least one supply shortage area as a destination;
determining a route to the destination; and
providing the route to a user utilizing the terminal device.

11. The method of claim 1, wherein the at least one indication further indicates data representing a transportation service request queue associated with the at least one supply shortage area.

12. The method of claim 11, wherein the data representing the transportation service request queue includes a number of requests waiting in the transportation service request queue.

13. A device for providing transportation service, comprising:
a communication interface configured to:
obtain a location of a terminal device; and
obtain supply and demand data for a region surrounding the location of the terminal device;
at least one memory; and
at least one processor coupled to the communication interface and the at least one memory, the at least one processor configured to:
identify at least one high demand area within the region;
identify at least one supply shortage area based on supply available in the at least one high demand area; and
provide at least one indication on the terminal device, the at least one indication indicating the at least one supply shortage area on a map.

14. The device of claim 13, wherein the map includes a heat map generated based on a number of transportation service requests received in the at least one supply shortage area and a number of service vehicles available to fulfill the transportation service requests in the respective supply shortage area.

15. The device of claim 13, wherein the communication interface is configured to obtain the supply and demand data from a transportation service management server.

16. The device of claim 13, wherein the supply and demand data comprises data representing a number of vehicles available to fulfill transportation service requests associated with each area in the region and data representing a number of transportation service requests received in the respective area.

17. The device of claim 13, wherein the at least one supply shortage area comprises a plurality of supply shortage areas, and wherein the at least one processor is further configured to:
rank the plurality of supply shortage areas based on a degree of shortage associated with the respective supply shortage areas; and
provide the ranking of the plurality of supply shortage areas to a user utilizing the terminal device.

18. The device of claim 13, wherein the at least one processor is further configured to:
identify one of the at least one supply shortage area as a destination;
determine a route to the destination, and
provide the route to a user utilizing the terminal device.

19. The device of claim 13, wherein the at least one indication further indicates data representing a transportation service request queue associated with the at least one supply shortage area.

20. A non-transitory computer-readable medium that stores a set of instructions, when executed by at least one processor of an electronic device, cause the electronic device to perform a method for providing transport service, the method comprising:
obtaining a location of a terminal device;
obtaining supply and demand data for a region surrounding the location of the terminal device;
identifying at least one high demand area within the region;
identifying at least one supply shortage area based on supply available in the at least one high demand area; and
providing, utilizing the terminal device, at least one indication indicating the at least one supply shortage area on a map.
